(19) United States
(12) Patent Application Publication
(10) Pub. No.: US 2004/0170784 A1
(43) Pub. Date: Sep. 2, 2004

(54) Container or a lid of thermoplastic material and a method for treating them

(76) Inventors: Poul Boysen, Vipperod (DK); Ole Kiilerich, Arhus C (DK)

Correspondence Address: Dykema Gossett, Suite 300 West, 1300 I Street NW, Washington, DC, 20005-3306, US

(21) Appl. No.: 10/478,433

(22) PCT Filed: May 22, 2002
(86) PCT No.: PCT/DK02/00342

(30) Foreign Application Priority Data
May 25, 2001 (SE) 0101857-1
May 25, 2001 (DK) PA 2001 00846

(51) Int. Cl. B05D 7/22; B05D 3/02

(52) U.S. Cl. 428/35.7; 427/535; 427/230; 427/384

(57) ABSTRACT

The present invention relates to a container of thermoplastic material. The container preferably has a bucket-form including a bottom-part with a lower and upper surface and a wall-part with an external and an inner surface wherein at least a part of the inner surface of the wall-part is coated. In a second aspect the invention relates to a lid of thermoplastic material. The lid is substantially disc-shaped with an upper and a lower side and optionally with a sealing device along the rim wherein at least a part of the lower side of the lid is coated. In a further aspect the invention relates to a method for treatment of thermoplastic material constituting a container or a lid. The invention also relates to the use of a container optionally in combination with a lid, for storing and transporting liquid paint and relates to the use of a method for manufacturing containers and/or lids for storage and transporting of liquid paint.

A container or a lid of thermoplastic material and a method for treatment of thermoplastic material constituting a container or a lid

The present invention relates to a container and a lid of thermoplastic material and use of the container and lid. The present invention also relates to a method for treatment of thermoplastic material constituting a container or a lid and use of the method.

Containers and lids, in particular containers and lids for paints based on water are normally produced by spray casting thermoplastic material into a desired shape at elevated temperatures. The thermoplastic material, which normally is used for such containers are polyethylenes and polypropylenes and similar thermoplastic material. The thermoplastic materials are selected due to their low cost and easy handling in the production line and moreover because they are acceptable with respect to protection of the environment.

When containers and lids of those thermoplastic materials are used for paints, preferably paints based on water, the liquid paint will cover the surfaces on the lid and the walls of the container which are in contact with the liquid paint. When the container is opened, by removing the lid, the water in the liquid paint will start evaporating and leave a layer of dry paint on the covered surfaces. As the liquid paint is used, the level of paint in the container will sink and more of the surface on the wall of the container will be left with a thin layer of paint which will become dry paint.

The dry paint on the surfaces of a container and a lid made from thermoplastic material has a strong tendency to peel off the surface. The effect of the dry paint peeling off the surface is in many situations highly undesired.

When a painter is using paint from such a container he will have the container left open for several hours during the working day. This will of course cause surfaces with a layer of dry paint in the container and on the lid as the water evaporates from the paint on these surfaces. If the painter does not use all the paint in the container, he will put on the lid to save the paint for the next working day. When the lid is removed from the container, the hardened paint tends to peel off and flakes of dry paint will drop into the liquid paint causing trouble when the liquid paint is used on a paint roller or in a spray gun.

The above problem with the dry paint that peel off has so far been solved either by the painter picking up the flakes of dry paint before using the paint or by using containers and lids made from metal. The first solution is inconvenient for the painter. The second solution using containers and lids made from metal is however a rather expensive solution and not the best with regard to the environment. Consequently there is a need for containers and lids where the problem described above is avoided and which containers and lids can be produced in a cost-effective way and moreover are acceptable with regard to the environment.

One object of the present invention is to provide an alternative solution to the problem stated above.

A second object of the present invention is to provide containers and lids of thermoplastic material having surfaces from which the tendency of paint to peel of is reduced significantly.

These objects and other objects are achieved by the invention as defined in the claims.

The invention provides containers and lids with excellent properties, in particular for use as containers and lids for liquid paint based on water. By use of the containers and lid for liquid paint it is avoided that dry paint peels off the surfaces and fall into the liquid paint as dry flakes. In the known containers and lids of thermoplastic material these flakes causes trouble in the painting tool. Thereby the container and lid according to the invention gives a good anti-peeling effect. Anti-peeling properties can be defined as a good ability to avoid that dry paint peels off the surface and substantially no dry paint peels off.

In one aspect the invention relates to a container of thermoplastic material. Preferably the container has a bucket-form including a bottom-part with a lower and upper surface and a wall-part with an external and an inner surface wherein at least a part of the inner surface of said wall-part is coated with a coating material providing a coating comprising isocyanate reacted with water.

By the term isocyanate reacted with water is understood that it is the reaction product of isocyanate hardened with water. The reaction product may of course contain traces of optionally catalysts and other additives.

The coating has properties which prevent liquid paint and other liquid from peeling off the coated surface when dried. This problem is well known in connection with containers of thermoplastic material like polyethylene and polypropylene. It is preferred that the container according to the invention is manufactured from polypropylene and having substantially a bucket-form which gives the best properties with regard to strength, material consumption and storage of liquid material. The container is preferably adapted to be closed with a lid to obtain a substantially airtight sealing.

In a preferred embodiment of the container according to the invention the coating comprising isocyanate reacted with water has a thickness between 5 and 100 μm, and more preferred between 10 and 70 μm. Such thickness of the coating gives the optimal anti-peeling properties and consumption of isocyanate.

It is preferred that the container has a coating comprising isocyanate reacted with water which is regularly distributed over the coated surface to provide a uniform layer on the coated surface. Moreover, in order to achieve the best anti-peeling properties, it is preferred that the amount of non-coated areas on the coated surface is less than 3% of the totally coated area which will provide the best properties with regard to anti-peeling.

In order to achieve containers with optimal anti-peeling properties it is preferred that the coating comprising isocyante reacted with water comprises from 6×10⁻⁴ g/cm² to 0,125 g/cm² isocyanate.

Moreover to obtain a container with good properties for a desired use as container for liquid paint it is preferred that the bottom-part and the wall-part of the container have a circular, oval, quadrangular or rectangular shaped cross section. These shapes are preferred for specific uses of paint, for instance it may be preferred that the container has quadrangular or rectangular shape when the paint is to be used on rollers.

The containers can of course be manufactured in any desired size, e.g. to contain 2½, 5 or 10 litres of liquid.

The invention also relates to the use of a container as previously described, and optionally in combination with a lid. The invention provides a closed container system for storing and transporting liquid paint having good anti-peeling properties.

In a second aspect the invention relates to a lid of thermoplastic material. The lid is substantially disc-shaped with an upper and a lower side and optionally with a sealing device along the rim wherein at least a part of the lower side of the lid is coated with a coating material providing a coating comprising isocyanate reacted with water. The sealing device may be any known device, e.g snap-lock or thread.

To obtain the best anti-peeling properties of the lid according to the invention it is preferred that the coating comprising isocyanate reacted with water has a thickness between 5 and 100 μm, and more preferred between 10 and 70 μm.

Moreover in a preferred embodiment of the lid the coating comprising isocyanate reacted with water is regularly distributed over the coated surface and preferably the amount of non-coated areas on the coated surface is less than 3% of the total coated area. Hereby it is possible to achieve the best anti-peeling properties.

Preferably the coating comprising isocyante reacted with water comprises from 6×10⁻⁴ g/cm² to 0,125 g/cm² of isocyanate.

In order to be adapted to containers of various shapes it is preferred that the lid can be manufactured in various shapes. Preferably the lid has a circular, oval, quadrangular or rectangular shaped cross section.

In a preferred embodiment the lid according to the invention is adapted to be placed over an opening of a container, preferably with the lower side facing the internal part of the container, and providing a substantially airtight sealing of said container. In this embodiment it is preferred that the internal surfaces of the lid on at least the wall-side of the container has a coating comprising isocyanate reacted with water.

The invention also relates to the use of a lid according to the invention in combination with a container for storing and transporting liquid paint.

Moreover the invention relates to a container system comprising a container having at least one surface comprising isocyanate reacted with water and a lid having at least one surface comprising isocyanate reacted with water and where the container and the lid are adapted to provide a substantially airtight sealing of the container system.

In a further aspect of the invention, the invention relates to a method for treatment of thermoplastic material constituting a container or a lid and the treatment comprises the steps of:

i) exposing at least one surface of the container or the lid to a corona treatment; and

ii) applying a layer of isocyanate to the corona treated surface; and

iii) applying water and optionally a catalyst to the surface; and

iv) hardening the layer of isocyanate.

The corona treatment is preferably a conventional corona treatment, optionally a flame or plasma treatment can be used. Preferred isocyanates are MDI or TDI or similar types of isocyanates with a relatively low vapour pressure.

Preferably the isocyanate is applied to the corona treated surface by one or more rollers, spray nozzles, brushes or sponges or similar applicators, which can apply a uniform layer of isocyanate to the corona treated surface.

According to the method it is preferred that the isocyanate is applied in an amount to provide a layer of isocyanate with a thickness between 5 and 100 μm and even more preferred a thickness between 10 and 70 μm on the treated surface. By this embodiment of the method good anti-peeling properties are obtained in the container or the lid.

In a preferred embodiment of the method according to the invention the isocyanate is applied to obtain a layer of regularly distributed isocyanate on the corona treated surface, and preferably non-coated areas on the treated surface constitute less than 3% of the total area of the treated surface. Hereby optimal anti-peeling properties are achieved.

Preferably the isocyanate is applied at a temperature of less than 60° C., and more preferred at a temperature of less than 50° C. This is to avoid too high or undesired evaporation of isocyanate. Preferably the temperature is higher than 10° C. as isocyanate tends to crystallize below this temperature.

In a preferred embodiment of the method according to the invention the isocyanate is applied in an amount of approximately 6×10⁻⁴ g/cm² to 0,125 g/cm². The application of such an amount secures that a stable and tight coating can be achieved.

According to the method it is preferred to apply a catalyst to the isocyante together with the water. The catalyst will decrease the time needed to harden the isocanate and form isocyanate reacted with water. The catalyst is preferably selected from the group consisting of amines, tin compounds or alcohols.

To achieve the best results using the method according to the invention it is preferred that step ii) in the method follows immediately after step i). Preferably step i) is followed by step ii) within 5 to 360 second, more preferred within 10 to 120 seconds. Hereby the best possible adherence between the thermoplastic material and the coating comprising isocyanate reacted with water is achieved.

The invention also relates to a container or a lid obtained by the method disclosed above.

Furthermore the invention relates to the use of the method disclosed above for manufacturing containers and/or lids for storage and transport of liquid paint, in particular paint based on water.

The invention will hereafter be described with reference to an example an a drawing wherein

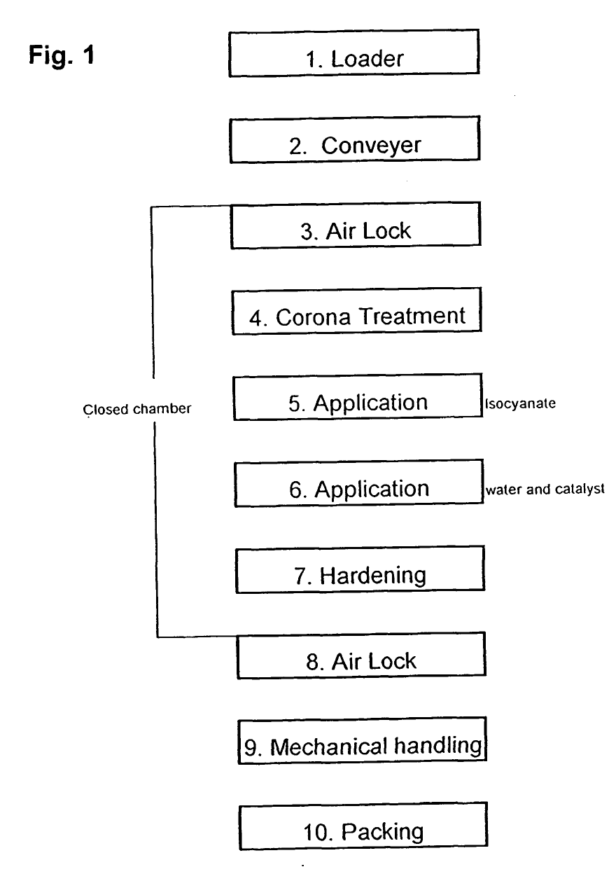

FIG. 1 shows a flowsheet of the method according to the invention.

### EXAMPLE

With reference to FIG. 1 the containers which are to be treated to obtain a coating of isocyanate reacted with water are brought to a loader 1 which places the containers on a conveyer 2.

The containers have substantially a bucket-shape and are manufactured from polypropylene. The convoyer 2 transports the containers to a closed chamber via an air lock 3. The closed chamber is necessary with respect to the environment. In the closed chamber the containers are exposed to a corona treatment 4 which is followed immediately by an application of isocyanate 6. The isocyanate is MDI and is applied with a spray nozzle. Next step 6 is application of water and a tertiary amine as catalyst. Hereafter the isocyanate is allowed to harden in a hardening zone 7.

After the treatment the containers leave the closed chamber via a second air lock 8 for mechanical handling, e.g. stacking and packing 10.

Lids for the containers are subjected to a similar process.

1. A paint container or a lid of thermoplastic material, said container and lid having an outer and an inner surface characterized in that at least a part of the inner surface of said container or lid is coated with a coating comprising isocyanate reacted with water.

2. A paint container or a lid according to claim 1, wherein said container has a substantially bucket-form including a bottom-part with a lower and upper surface and a wall-part with an outer and an inner surface.

3. A paint container or a lid according to claim 1, wherein said lid is substantially disc-shaped with an upper and a lower surface and optionally comprises a sealing device along the rim.

4. A paint container or a lid according to claims 1-3, wherein said coating has a thickness between 5 and 100 μm, preferably between 10 and 70 μm.

5. A paint container or a lid according to any one of the preceding claims, wherein said coating is regularly distributed over the surface and preferably the amount of non-coated areas on the surface is less than 3% of the total coated area.

6. A paint container or a lid according to any one of the preceding claims, wherein said coating comprises from 6×10⁻⁴ g/cm² to 0.125 g/cm² isocyanate.

7. A paint container or a lid according to any one of the preceding claims, wherein said bottom-part and wall-part of the container has a circular, oval, quadrangular or rectangular shaped cross section.

8. A paint container or a lid according to any one of the preceding claims, wherein said lid has a circular, oval, quadrangular or rectangular shaped cross section.

9. A paint container or a lid according to any one of the preceding claims, wherein said lid is adapted to be placed over an opening of a container, preferably with the lower surface facing the inner part of the container, and to provide a substantially airtight sealing of said container.

10. Use of a paint container and a lid according to claims 1 to 9 for storing and transporting liquid paint.

11. A container system comprising a container and a lid according to claims 1 to 9, wherein the container and the lid are adapted to provide a substantially airtight sealing of said container.

12. A method for treatment of thermoplastic material constituting a paint container or a lid having an outer and an inner surface comprising the steps of:
i) applying a layer of isocyanate to the inner surface of the container or lid,
ii) applying water and optionally a catalyst to the inner surface; and
iii) hardening the layer of isocyanate.

13. A method according to claim 12, wherein said method further comprises a step of exposing at least one surface of said paint container or lid to a corona treatment before applying a layer of isocyanate.

14. A method according to claims 12 or 13, wherein the isocyanate is applied to the inner surface by one or more rollers, spray nozzles, brushes or sponges.

15. A method according to any one of claims 12 to 14, wherein isocyanate is applied in an amount to provide a layer of isocyanate with a thickness between 5 and 100 μm, preferably between 10 and 70 μm.

16. A method according to any one of claims 12 to 15, wherein isocyanate is applied to obtain a layer of regularly distributed isocyanate on the surface, preferably non-coated areas on the surface constitute less than 3% of the total area of the surface.

17. A method according to any one of claims 12 to 16, wherein isocyanate is applied at a temperature of less than 60° C., preferably less than 50° C.

18. A method according to any one of claims 12 to 17, wherein isocyanate is applied in an amount of 6×10⁻⁴ g/cm² to 0.125 g/cm².

19. A method according to claim 12, wherein the catalyst is selected from the group consisting of amines, tin compounds or alcohols.

20. A method according to claim 12, wherein step ii) follows immediately after step i).

21. A paint container or a lid obtained by the method according to any one of claims 12 to 20.

22. Use of the method according to claims 12 to 20 for manufacturing paint containers and/or lids for storage and transport of liquid paint.
